(19) United States
(12) Patent Application Publication
(10) Pub. No.: US 2026/0099509 A1
(43) Pub. Date: Apr. 9, 2026

(54) MULTI-STAGE SEISMIC DATA INTERPOLATION

(71) Applicant: SCHLUMBERGER TECHNOLOGY CORPORATION, Sugar Land, TX (US)

(72) Inventors: Phillip BILSBY, Crawley (GB); Massimiliano VASSALLO, Crawley (GB); Alexander ZARKHIDZE, Crawley (GB); Rajiv KUMAR, Crawley (GB)

(21) Appl. No.: 19/107,071

(22) PCT Filed: Aug. 31, 2022
(86) PCT No.: PCT/US2022/042151

§ 371 Date: Feb. 27, 2025

(51) Int. Cl. G06F 16/25

(52) U.S. Cl. CPC G06F 16/258

(57) ABSTRACT

A method for generating resolved data is disclosed. The method receives captured data in a first signal space from sensors at a resource site and determines a signal characteristic associated with a first signal component, a second signal component, or a noise component within the captured data. The method transforms the captured data from the first signal space to a second signal space using a first transform operator. The method further extracts a first signal component from the transformed captured data in the second signal space. The extracted first signal component may be transformed back to the first signal space to generate a first extracted data which may be subtracted from the captured data. The method reconstructs the first extracted data to generate a first reconstructed data included in the resolved data. The resolved data includes a minimal amount of a noise component associated with the captured data.

### BACKGROUND

Acquired data (e.g., seismic data) at resources sites often contain various modes of energy due to reflection, refraction, and diffraction in the presence of coherent noise. When the acquired data is processed together, weaker modes of energy are often lost at the cost of preserving stronger modes of energy. For example, merely interpolating data points within the acquired data in one go may result in a loss of weaker energy modes buried beneath the strong noise or other stronger energy modes of interest.

Moreover, in acquisition scenarios where one mode of seismic energy dominates the dynamic range in the transform domain (e.g., frequency domain), the quality of interpolation may be biased by the dominating mode since the sparse priors estimated at the lower frequencies are influenced by the strongest mode of energy. Thus, the probability of losing the weak coherent energy buried beneath the strongest mode is highly likely. As a result, the interpolation is sub-optimal and loss of weak coherent energy can have a significant impact on post-processing steps after interpolation. This often leads to issues such as poor resolution of resource site data, noisy resource site data, etc.

### SUMMARY

This disclosure is directed to methods and systems that provide a multi-stage process for progressively interpolating different modes of seismic energy within captured data at a resource site. According to some embodiments, the multi-stage approach uses a combination of prior-based matching pursuit Fourier interpolation (MPFI) techniques along with executing processing operations that minimize strong noise or other unwanted signal events present in acquired data (e.g., seismic data) at a resource site. One such example is executing an interpolation operation on captured data associated with land-based resource sites such as acquired data contaminated with surface waves. In such scenarios, a multi-stage MPFI process along with a surface-wave analysis, modelling, and inversion (SWAMI) technique may be combined to reconstruct signal components with contributions from reflection, refraction, and diffraction events and which are sometimes buried beneath the strong surface wave signals within the acquired data. At each stage of the multi-stage process, a particular mode of seismic energy/event within the captured data may be reconstructed in a signal safe manner. Said particular mode of seismic energy may be removed from the input data including the captured data such that other modes of seismic energy may be subsequently reconstructed from the input data.

According to some implementations, the multi-stage approach starts with interpolating the strongest seismic modes of energy (e.g., surface waves in land data acquisition-type resource sites) first and steadily progresses to interpolating lesser seismic modes of energy. The benefits of this multi-stage strategy are that at each interpolation stage, attention is given to one particular mode of energy by interpolating said particular mode of energy in signal-safe manner, while keeping the other modes of energies intact in the input or captured data. Once the particular mode of seismic energy is interpolated, the particular mode of seismic energy is removed from the captured or raw input data. Other modes of seismic energy may be similarly surgically extracted from the captured data and subsequently interpolated. The proposed approach improves the performance of interpolation and thus facilitates generation of more accurate renditions of, for example, image data that may be visualized with higher resolution relative to the raw captured data from the resource site.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows an exemplary high-level flowchart for extracting and generating resolved data associated with a resource site.

FIG. 2 shows a cross-sectional view of a resource site for which the process of FIG. 1 may be executed.

FIG. 3 shows a high-level networked system diagram illustrating a communicative coupling of devices or systems associated with the resource site of FIG. 2.

FIG. 4A-4E show exemplary detailed flowcharts for generating resolved data derived from signal components within captured data from a resource site.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to the some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. More specifically, the systems and methods presently disclosed may be applicable to exploring resources such as oil, natural gas, water, and Salar brines.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

### High-Level Flowchart

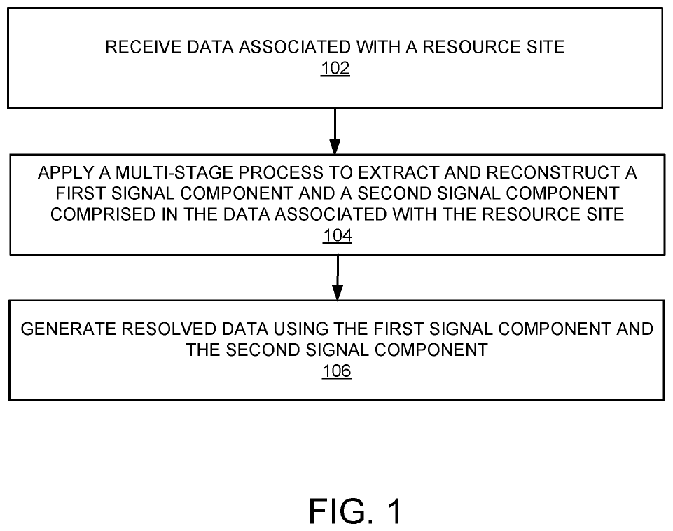

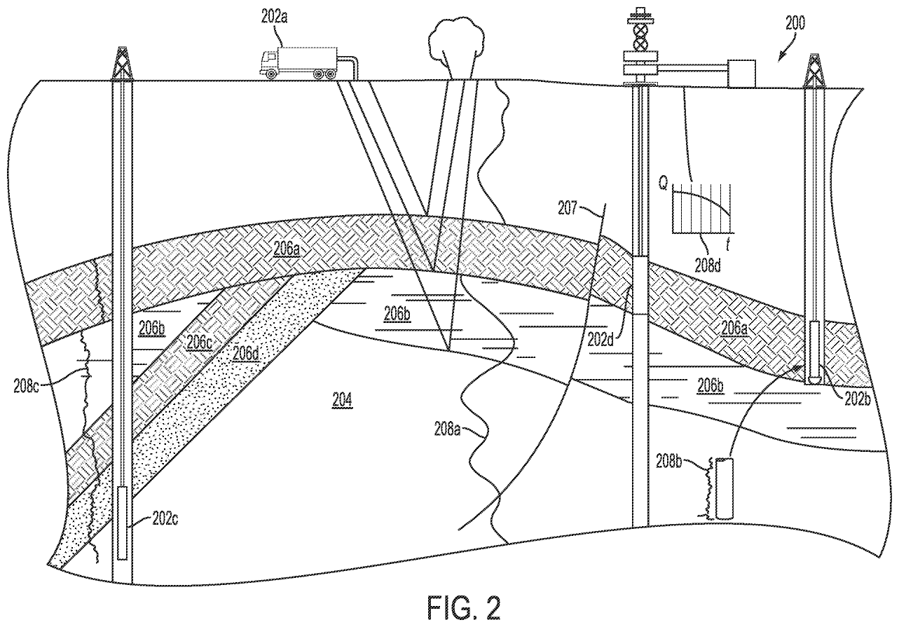

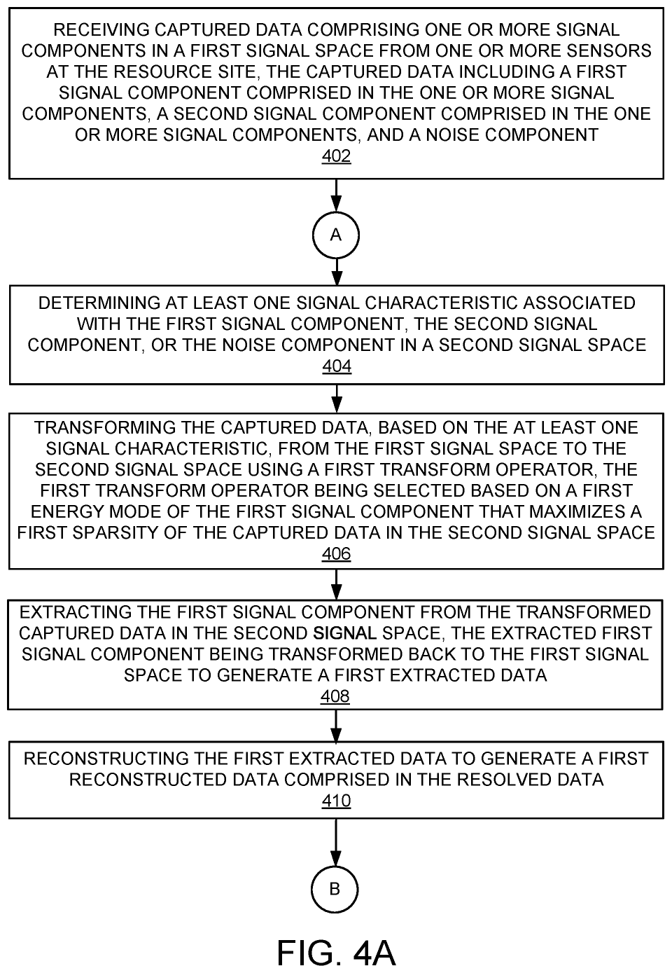

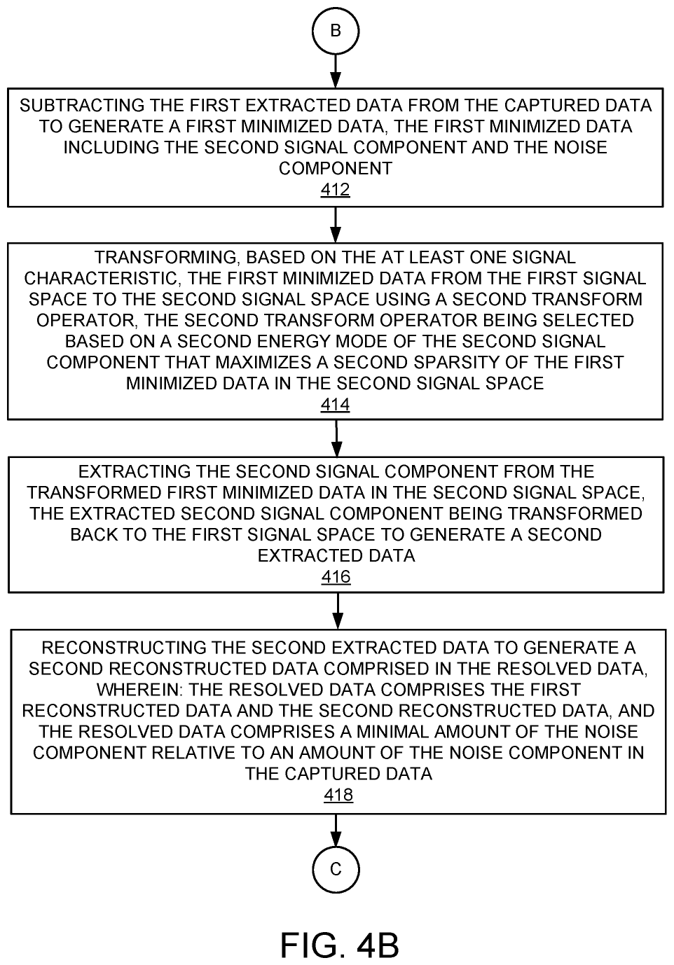

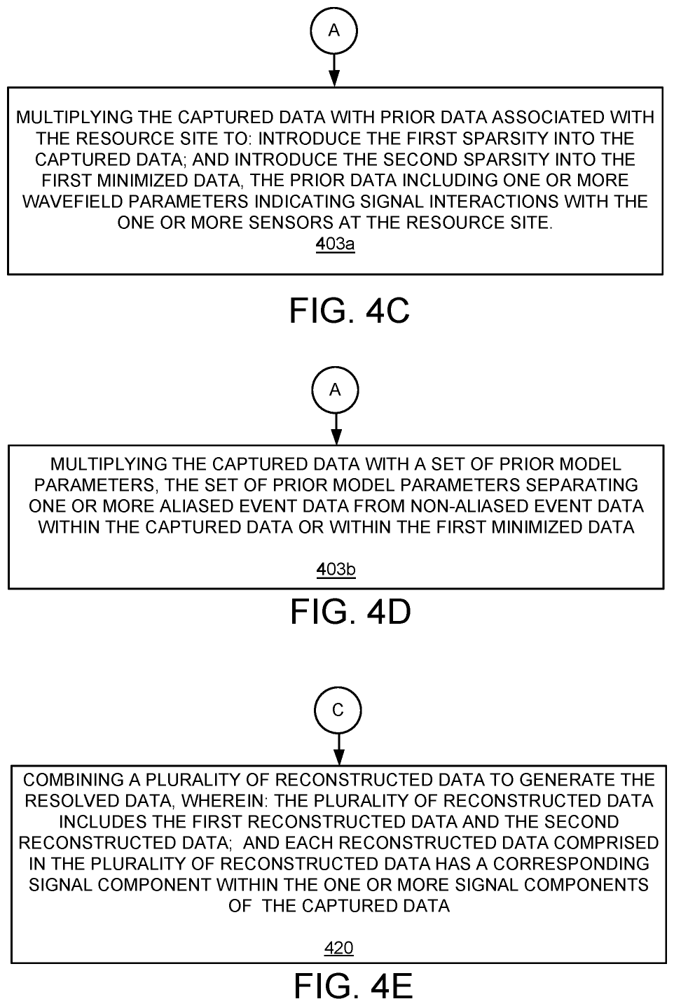

FIG. 1 shows an exemplary high-level flowchart for extracting and generating resolved data associated with a resource site. The exemplary flowchart shown begins with receiving, at block 102, receiving data associated with a resource site. The data may include seismic data, wellbore logging data, or other data discussed in association with a resource site 200, such as that illustrated in FIG. 2. At block 104, a multi-stage process is applied to extract and reconstruct a first signal component and a second signal component included in the data associated with the resource site. Continuing at block 106 of FIG. 1, resolved data is generated using the extracted and reconstructed first and second signal components. In one embodiment, the captured data may include a plurality of signal components other than the first signal component and the second signal component. Moreover, any signal component included in the captured data from the resource site may have a corresponding mode of energy, or particular spectral parameters that define said signal component. These and other aspects are further discussed in association with the flowcharts of FIGS. 4A-4D.

### Resource Site

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, etc. According to some embodiments, various measurement tools capable of sensing one or more parameters such as seismic two-way travel time, density, resistivity, production rate, etc., of a subterranean formation and/or geological formations are analyzed at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through one or more layers, such as the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the oil field 200 may contain a variety of geological structures and/or formations, sometimes having extreme complexity. In some locations of a given geological structure, for example below a water line relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc.

Data acquisition tool 202a is illustrated as a measurement truck, which may include devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the oil field 200 to collect data relating to various oil field operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the formation, wellbore, formation fluid/gas, wellbore fluid, gas/oil/water included in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high resolution result set used to, for example, generate a resource model.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as Dielectric Scanner™ (mark of Schlumberger); acoustic tools including sonic sensors, such as Sonic Scanner™ (mark of Schlumberger) or ultrasonic sensors, such as pulse-echo sensor as in UBI™ or PowerEcho™ (marks of Schlumberger) or flexural sensors PowerFlex™ (mark of Schlumberger); nuclear sensors such as Litho Scanner™ (mark of Schlumberger) or nuclear magnetic resonance sensors; fluid sampling tools including fluid analysis sensors such as InSitu Fluid Analyzer™ (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

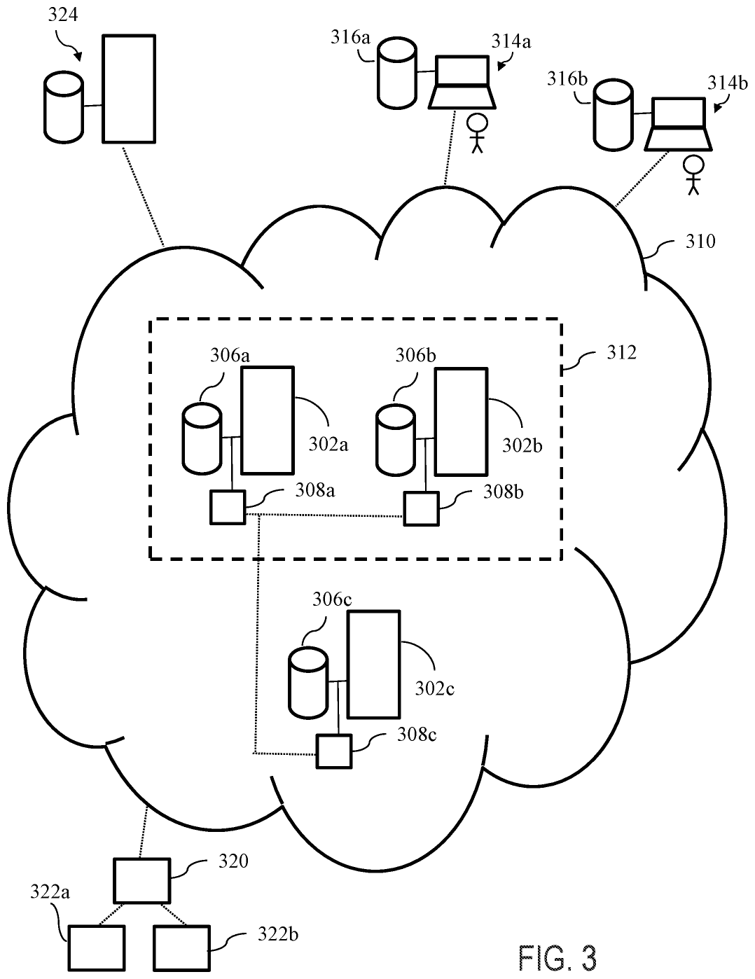

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the oil field 200. In one embodiment, the data is stored in separate databases, or combined into a single database.

### High-Level Networked System

FIG. 3 shows a high-level networked system diagram illustrating a communicative coupling of devices or systems associated with the resource site 200. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the oil field 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more oil fields 200 having, for example, a set of terminals 320, each including at least a processor, a memory, and a communication device for communicating with other devices communicatively coupled to the cloud-computing platform 310. The resource site 200 may also have one or more sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the one or more sensors/sensor interfaces 322a and 322b may be processed to generate a one or more resource models or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing and/or application specific integrated circuits.

Further, the steps in the flowcharts described below may be implemented by running one or more functional modules in an information processing apparatus such as general-purpose processors or application specific chips, such as ASICs, FPGAs, PLDs, GPUS or other appropriate devices associated with the system of FIG. 3. For example, the flowchart of FIG. 1 as well as the flowcharts below may be executed using a signal processing engine stored in memory 306a, 306b, or 306c such that the signal processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs include instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### EMBODIMENTS

Embodiments related to extracting specific data within captured data associated with a resource site and using extracted data to generate resolved data are now discussed. For context, prior data associated with the resource site or simply, priors, may be used to stabilize data reconstruction of one or more signal components included in captured resource site data (e.g., seismic data) across the frequency spectrum. However, the quality of seismic data interpolation across all modes of energy due to reflection, refraction, diffractions in the presence of strong noise such as surface waves depends on the dynamic range of all the modes present in the captured data (e.g., captured seismic data) at the resource site. A multi-stage strategy is disclosed which stabilizes the data interpolation for scenarios where seismic data is contaminated by strong variation(s) in the dynamic range of the different modes of energy in the transform domain. The multi-stage Matching pursuit Fourier Interpolation (MPFI) interpolation using priors may be implemented using the following relationship:

$${min}_{x} {\sum }_{n = 1}^{N} {‖ M 𝒟 {Q}_{n} {P}_{n} {x}_{n} - {b}_{n} ‖}_{2}^{2} subject to {‖ {x}_{n} ‖}_{0} \leq N , \qquad ( 1 )$$

wherein

$${\{ {Q}_{n} \}}_{n = 1}^{N}$$

encompasses various suits of prior information that enhance the sparsity of the signal in the transform domain [symbol] and xₙ represents a specific mode of seismic energy at each stage of the multi-stage process. Note that Pₙ represents a prior model, whereas Qₙ is based on prior information about the wavefield from which the captured data is generated. In some implementations, various kinds of prior information (Qₙ) such as moveout associated with a propagated signal followed by extracting the specific mode of data (e.g., seismic data) in a localized region can be used depending on the environment in which the data is being acquired at the resource site. In one embodiment, an N-stage strategy interpolation strategy may be used where in each stage (say n), a specific signal mode of energy may be iteratively solved for while concurrently ignoring all other energetic modes (e.g., lesser energetic modes relative to the specific signal mode of energy).

While solving for a specific signal mode, two techniques may be employed. The first technique may interpolate the strongest signal mode, project the strongest signal mode back to the acquisition grid including the acquired data, subtract data associated with the strongest signal mode from the acquired data, and continue with the next stage. The second technique may predict the strongest mode of energy without performing any initial interpolation. For a land environment at the resource site, one such scenario is first estimating a fundamental mode of energy using both direct and/or scattering components of a signal associated with a surface wave energy using surface-wave analysis, modelling, and inversion (SWAMI) techniques then subtract the estimated fundamental mode of energy from the acquired or input data to generate minimized data. Further interpolation may be performed across the remaining modes of seismic energy within the minimized data as the case may be using equation (1) above. This beneficially allows to account for spatially varying phase velocity-frequency dispersive characteristics of the surface wave energy within the captured data that can be significant and complex even over very short distances. As well as managing this complex spatial variation, the ability to surgically remove aliased and scattered surface wave energy without the need of interpolation in advance provides a benefit for the disclosed multi-stage interpolation process relative to velocity discrimination filters. It is appreciated that after each stage, the estimated data xₙ may be projected back to the acquisition grid including the acquired data (e.g., acquired seismic data) and subtracted from the residual of the previous stage bₙ₋₁ using the following relationship:

$${b}_{n} = {b}_{n - 1} - M 𝒟 {Q}_{n} {P}_{n} {x}_{n} \qquad ( 2 )$$

In some embodiments, the multi-stage interpolation process may optionally or additionally include the following stages:
(i) identifying different modes of seismic energy within data acquired at the resource site;
(ii) determining whether at any stage of the multi-stage process, the dedicated mode of the strongest seismic signal can be extracted either using an interpolation technique (e.g., prior-based interpolation technique) or by using a custom technology for such a purpose. In one embodiment, such a dedicated or custom technology includes the use of SWAMI (if the resource site includes land environments) to extract all possible surface wave modes;
(iii) once the strongest mode is extracted, the strongest mode is projected back to the acquisition grid including the acquired data and then subsequently subtracted from the acquired data or input data;
(iv) steps (i-iii) may be executed for the next strongest mode of seismic energy.

Note that, the proposed approach is not limited to land acquisition scenarios alone but can be applied to any acquisition environment such as marine where ocean-bottom node data is often contaminated by swell noise, Scholte waves or any other mode of seismic events which prevent interpolation to produce optimal results.

Moreover, it is appreciated that there may be a couple of challenges in acquisition environments such as the resource sites discussed in this disclosure that are worth noting. These challenges include:

(i) Strong variations in the dynamic range: Acquired data (e.g., seismic data) from resource sites include different modes of energy propagation which when recorded exhibit different dynamic ranges in the transform domain. Therefore, processes such as interpolation need some support to preserve both the stronger and weaker modes of coherent energy. Prior information from the low-frequency spectrum may be used to facilitate interpolations at higher frequencies of the acquired data. However, if the energy in the localized temporal-spatial window includes a strong overlay on top of weaker energy, then usage of prior information alone may not guarantee the preservation of the weaker modes of energy in the acquired data relative to the higher modes of energy within the acquired data.
(ii) Coherent background noise: Apart from variations in the dynamic range, acquired data (e.g., seismic data) from resource sites may be contaminated with coherent noise associated with surface waves such as ground roll scholte waves and shear noise or mudroll. When performing prior-based interpolation in the presence of strong coherent noise, the priors may be biased by the strong coherent noise or some other strong signal. Thus, the probability of picking the weaker coherent events or lower energy modes is very low (e.g., less than 0.25% or less than 0.5% or less than 1% or less than 1.5%). As a result of this, the chances of preserving the weaker coherent lower energy modes buried beneath the strong noise is very low, which can significantly affect the quality of processing workflows post interpolation.

The disclosed methods and systems exploit a multi-stage strategy where at each stage, one mode of energy may be extracted and reconstructed from the acquired data. In some embodiments, the methods extract the strongest mode of energy or use custom techniques in combination with interpolation to process a particular mode of energy. One such scenario is combining SWAMI techniques with interpolation to first remove all surface wave modes from the data followed by performing prior-based seismic data interpolation to preserve weaker modes of seismic energy buried beneath the strong surface waves. The proposed approach produces significantly better results in post-processing operations such as generating noise-free multi-dimensional (1-dimensional, 2-dimensional, 3-dimensional) visualizations such as images for rendering on a display device. It is appreciated that the proposed multi-stage interpolation approach can be used for any acquisition environment or resource site with any acquisition design including regular and irregular geometries where the seismic data is contaminated by strong noise or other signal events which may not be desirable for subsequent post-processing techniques such as migration or inversion. The proposed multi-stage framework for interpolating certain modes of seismic energy (e.g., use of SWAMI for surface waves) will enable the preservation and reconstruction of all possible weaker modes of seismic within the acquired data from the resource site, which would otherwise be lost during post-processing operations. Moreover, the disclosed technologies enable a cost-efficient interpolation solution both qualitatively and/or quantitatively for data acquisition environments such as land, ocean-bottom node, or shallow water towed streamer scenarios. The fact that certain modes of seismic energy may be extracted and separately processed using, for example, custom techniques such as SWAMI can provide more stable solutions instead of merely using plain interpolation techniques alone for all the acquired data.

### Additional Flowcharts

FIG. 4A-4D show exemplary detailed flowcharts for generating resolved data derived from signal components within captured data from a resource site. In particular, FIG. 4A illustrates an embodiment of a method for generating resolved data using captured data from a resource site. At block 402, the method receives, using a computer processor, the captured data including one or more signal components in a first signal space from one or more sensors at the resource site. The captured data may include a first signal component included in the one or more signal components, a second signal component included in the one or more signal components, and a noise component. At block 404, the method determines at least one signal characteristic associated with the first signal component, the second signal component, or the noise component in a second signal space. According to some implementations, the at least one signal characteristic includes at least one of: a variation in dynamic range, kinematics data associated with the one or more signal components, and signal moveout data associated with the one or more signal components. At block 406, the method transforms, based on the at least one signal characteristic, the captured data from the first signal space to the second signal space using a first transform operator. The first transform operator can be selected based on a first energy mode of the first signal component that maximizes a first sparsity of the captured data in the second signal space. At block 408, the method extracts the first signal component from the transformed captured data in the second signal space. The extracted first signal component may be transformed back to the first signal space to generate a first extracted data. The method at block 410 reconstructs the first extracted data to generate a first reconstructed data included in the resolved data.

In one embodiment, the method at block 412 subtracts the first extracted data from the captured data to generate a first minimized data. In some cases, the subtraction is based on the first reconstructed data such that the first reconstructed data is removed from the captured data to generate the first minimized data. This subtraction operation may be carried out in the second signal space according to some implementations. The first minimized data, for some embodiments, includes the second signal component and the noise component. Furthermore, the method at block 414 transforms, based on the at least one signal characteristic, the first minimized data from the first signal space to the second signal space using a second transform operator. The second transform operator, for some embodiments, is selected based on a second energy mode of the second signal component that maximizes a second sparsity of the first minimized data. In addition, the method extracts, at block 416, the second signal component from the transformed first minimized data in the second signal space. The extracted second signal component, for some embodiments, is transformed back to the first signal space to generate a second extracted data. In some embodiments, the method, at block 418 reconstructs the second extracted data to generate a second reconstructed data included in the resolved data. It is appreciated that the resolved data includes the first reconstructed data and the second reconstructed data. It is further appreciated that the resolved data includes a minimal amount of the noise component relative to an amount of the noise component in the captured data.

The method, at 403a, multiplies the captured data with prior data associated with the resource site to introduce the first sparsity into the captured data, and to introduce the second sparsity into the first minimized data, respectively. According to some implementations, the method formats the prior data and/or the captured data into a matrix structure or a vector structure prior to executing the multiplication operation. In some embodiments, the prior data includes one or more wavefield parameters (e.g., numerical or quantitative wavefield parameters) that indicate signal interactions with the one or more sensors at the resource site. In addition, the method, at block 403b may multiply the captured data with a set of prior model parameters. The set of prior model parameters may separate one or more aliased event data from non-aliased event data within the captured data or within the first minimized data.

These and other implementations may each optionally include one or more of the following features. The prior data may include noise attenuation data associated with the resource site, frequency bandwidth data associated with the resource site, and/or data associated with localizing the first energy mode using a pre-defined mute operation that reduces the noise component within the captured data. The first energy mode, according to some embodiments, is greater in magnitude (in for example, the second signal space) relative to remaining energy modes including the second energy mode of the captured data. The prior data may also include velocity data associated with the captured data and/or data associated with moveout of a plurality of mode parameters associated with the captured data. The plurality of mode parameters includes one or more of a direct arrival mode parameter, a reflection mode parameter, a refraction mode parameter, a diffraction mode parameter, a surface wave mode parameter, a scholte wave mode parameter, a shear noise mode parameter, and a mudroll mode parameter. It is appreciated that these parameters are associated with transmitted and/or received signals used by the one or more sensors to generate the captured data.

Turning to FIG. 4E, the method, for some embodiments, at block 420, combine a plurality of reconstructed data to generate the resolved data. The plurality of reconstructed data may include the first reconstructed data and the second reconstructed data such that each reconstructed data included in the plurality of reconstructed data has a corresponding signal component within the one or more signal components of the captured data. In one embodiment, the captured data includes seismic event data captured by the one or more sensors at the resource site. The seismic event data may include one or more of: particle count data, velocity data, displacement data, and acceleration data. The seismic event data may be captured at one or more of: a regular grid segment of the resource site such that captured data samples do not deviate from a periodic grid in an irregular fashion, and/or at an irregular grid segment of the resource site such that captured data samples deviate from a periodic grid in an irregular fashion.

In some embodiments, reconstructing the first extracted data, or the second extracted data, or a third extracted data, or an n-th extracted data includes applying one or more of a sparsity-based interpolation technique to interpolate the first extracted data or the second extracted data, or the third extracted data or an n-th extracted data generated from the captured data using the process illustrated in FIGS. 4A-4E. Thus, the process illustrated in FIGS. 4A-4E may be applied to iteratively reconstruct a plurality of signal components within the captured data based on the at least one signal characteristic and/or based on one or more signal modes associated with the plurality of signal components within the captured data. During the last iteration stage of the data reconstruction process for the one or more signal components within the captured data using the process of FIGS. 4A-4E, it is contemplated that the reconstruction process used to generate the resolved data may be terminated based on an exhaustion of the prior data associated with the resource site and/or a finding that additional information associated with the at least one signal characteristic discussed in association with FIGS. 4A-4E is unavailable. It is appreciated that the sparsity-based technique discussed above may include one or more of: a Matching Pursuit Fourier Interpolation (MPFI) technique, or a rank-minimization interpolation technique. Other techniques applied to reconstructing the first extracted data or the second extracted data or the n-th extracted data include a surface-wave analysis, modelling, and inversion (SWAMI) technique, a debbuble technique, a random noise attenuation technique, a noise burst attenuation technique, or a direct arrival removal technique.

In some implementations, the first energy mode includes at least one spectral parameter having a first value that falls within a first range of values. The second energy mode may include at least one spectral parameter having a second value that falls within a second range of values. In addition, the first signal space is a time signal space, and the second signal space is a frequency signal space. In other words, the time signal space refers to a time-domain signal space whereas the frequency signal space refers to a frequency-domain signal space. Furthermore, the resolved data includes image data associated with one or more sections of the resource site. The image data may be rendered on a graphical user interface of a computing device. In addition, the first transform operator or the second transform operator may include one of: a Fourier transform operator, a Redon transform operator, a Wavelet transform operator, or a Curvelet transform operator. It is appreciated that the captured data may include seismic data generated from one or more surveys conducted at the resource site.

The systems and methods described in this disclosure enable improvements in autonomous operations at resource sites such as oil and gas fields. The systems and methods described allow an ordered combination of new results in autonomous operations including wireline and testing operations with existing results. The systems and methods described cannot be performed manually in any useful sense. Simplified systems may be used for illustrative purposes but it will be appreciated that the disclosure extends to complex systems with many constraints thereby necessitating new hardware-based processing system described herein. The principles disclosed may be combined with a computing system to provide an integrated and practical application to achieve autonomous operations in oil and gas fields.

These systems, methods, processing procedures, techniques, and workflows increase effectiveness and efficiency. Such systems, methods, processing procedures, techniques, and workflows may complement or replace conventional methods for identifying, isolating, transforming, and/or processing various aspects of data that is collected from a subsurface region or other multi-dimensional space to enhance flow simulation prediction accuracy.

A benefit of the present disclosure is that more effective methods for downhole operations may be employed. It will be appreciated that the application and benefit of the disclosed techniques are not limited to subterranean wells and reservoirs and may also be applied to other types of energy explorations and/or other resource explorations (e.g., aquifers, Lithium/Salar brines, etc.).

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for generating resolved data using captured data from a resource site, the method comprising:
receiving, using a computer processor, the captured data including one or more signal components in a first signal space from one or more sensors at the resource site, the captured data including:
a first signal component included in the one or more signal components,
a second signal component included in the one or more signal components, and
a noise component,
determining, using the computer processor, at least one signal characteristic associated with the first signal component, the second signal component, or the noise component in a second signal space;
transforming, using the computer processor and based on the at least one signal characteristic, the captured data from the first signal space to the second signal space using a first transform operator, the first transform operator being selected based on a first energy mode of the first signal component that maximizes a first sparsity of the captured data in the second signal space;
extracting, using the computer processor, the first signal component from the transformed captured data in the second signal space, the extracted first signal component being transformed back to the first signal space to generate a first extracted data;
reconstructing, using the computer processor, the first extracted data to generate a first reconstructed data included in the resolved data;
subtracting, using the computer processor, the first extracted data from the captured data to generate a first minimized data, the first minimized data including the second signal component and the noise component;
transforming, using the computer processor and based on the at least one signal characteristic, the first minimized data from the first signal space to the second signal space using a second transform operator, the second transform operator being selected based on a second energy mode of the second signal component that maximizes a second sparsity of the first minimized data in the second signal space;
extracting, using the computer processor, the second signal component from the transformed first minimized data in the second signal space, the extracted second signal component being transformed back to the first signal space to generate a second extracted data; and
reconstructing, using the computer processor, the second extracted data to generate a second reconstructed data included in the resolved data, wherein:
the resolved data includes the first reconstructed data and the second reconstructed, and
the resolved data includes a minimal amount of the noise component relative to an amount of the noise component in the captured data.

2. The method of claim 1, comprising multiplying the captured data with prior data associated with the resource site to:
introduce the first sparsity into the captured data, and
introduce the second sparsity into the first minimized data, the prior data including one or more wavefield parameters indicating signal interactions with the one or more sensors at the resource site.

3. The method of claim 2, wherein:
the prior data includes noise attenuation data associated with the resource site,
the prior data includes frequency bandwidth data associated with the resource site,
the prior data includes data associated with localizing the first energy mode using a pre-defined mute operation, the first energy mode being greater in magnitude relative to remaining energy modes including the second energy mode of the captured data,
the prior data includes velocity data associated with the captured data, and
the prior data includes data associated with moveout of a plurality of mode parameters associated with the captured data.

4. The method of claim 3, wherein the plurality of mode parameters includes one or more of:
a direct arrival mode parameter,
a reflection mode parameter,
a refraction mode parameter,
a diffraction mode parameter,
a surface wave mode parameter,
a scholte wave mode parameter,
a shear noise mode parameter, and
a mudroll mode parameter.

5. The method of claim 1, comprising combining a plurality of reconstructed data to generate the resolved data, wherein:
the plurality of reconstructed data includes the first reconstructed data and the second reconstructed data, and
each reconstructed data included in the plurality of reconstructed data has a corresponding signal component within the one or more signal components of the captured data.

6. The method of claim 1, wherein the captured data includes seismic event data captured by the one or more sensors at the resource site.

7. The method of claim 6, wherein the seismic event data includes one or more of:
particle count data,
velocity data,
displacement data, and
acceleration data.

8. The method of claim 6, wherein the seismic event data is captured at one or more of:
a regular grid segment of the resource site such that captured data samples do not deviate from a periodic grid in an irregular fashion, and
an irregular grid segment of the resource site such that captured data samples deviate from a periodic grid in an irregular fashion.

9. The method of claim 1, comprising multiplying the captured data with a set of prior model parameters, the set of prior model parameters separating one or more aliased event data from non-aliased event data within the captured data or within the first minimized data.

10. The method of claim 1, wherein reconstructing the first extracted data or the second extracted data includes applying one or more of:
a sparsity-based interpolation technique to interpolate the first extracted data or the second extracted data,
a surface-wave analysis, modelling, and inversion (SWAMI) technique,
a debbuble technique,
a random noise attenuation technique,
a noise burst attenuation technique, or
a direct arrival removal technique.

11. The method of claim 10, wherein the sparsity-based interpolation technique includes one or more of:
a Matching Pursuit Fourier Interpolation (MPFI) technique, or
a rank-minimization interpolation technique.

12. The method of claim 1, wherein the at least one signal characteristic includes one of:
a variation in dynamic range,
kinematics data associated with the one or more signal components, and
signal moveout data associated with the one or more signal components.

13. The method of claim 1, wherein:
the first energy mode includes at least one spectral parameter having a first value that falls within a first range of values, and
the second energy mode includes at least one spectral parameter having a second value that falls within a second range of values.

14. The method of claim 1, wherein:
the first signal space is a time signal space, and
the second signal space is a frequency signal space.

15. The method of claim 1, wherein the resolved data includes image data associated with one or more sections of the resource site, the image data being rendered on a graphical user interface of a computing device.

16. The method of claim 1, wherein the first transform operator or the second transform operator includes one of:
a Fourier transform operator,
a Redon transform operator,
a Wavelet transform operator, or
a Curvelet transform operator.

17. A system for generating resolved data using captured data from a resource site, the system comprising:
a computer processor, and
memory storing a signal processing engine that includes instructions that are executable by the computer processor to:
receive the captured data including one or more signal components in a first signal space from one or more sensors at the resource site, the captured data including:
a first signal component included in the one or more signal components,
a second signal component included in the one or more signal components, and
a noise component,
determine at least one signal characteristic associated with the first signal component, the second signal component, or the noise component in a second signal space;
transform, based on the at least one signal characteristic, the captured data from the first signal space to the second signal space using a first transform operator, the first transform operator being selected based on a first energy mode of the first signal component that maximizes a first sparsity of the captured data in the second signal space;
extract the first signal component from the transformed captured data in the second signal space, the extracted first signal component being transformed back to the first signal space to generate a first extracted data;
reconstruct the first extracted data to generate a first reconstructed data included in the resolved data;
subtract the first extracted data from the captured data to generate a first minimized data, the first minimized data including at least the second signal component and the noise component;
transform, based on the at least one signal characteristic, the first minimized data from the first signal space to the second signal space using a second transform operator, the second transform operator being selected based on a second energy mode of the second signal component that maximizes a second sparsity of the first minimized data in the second signal space;
extract the second signal component from the transformed first minimized data in the second signal space, the extracted second signal component being transformed back to the first signal space to generate a second extracted data; and
reconstruct the second extracted data to generate a second reconstructed data included in the resolved data, wherein:
the resolved data includes the first reconstructed data and the second reconstructed data, and
the resolved data includes a minimal amount of the noise component relative to an amount of the noise component in the captured data.

18. The system of claim 17, wherein:
the resolved data includes a plurality of reconstructed data including the first reconstructed data and the second reconstructed data, and
each reconstructed data included in the plurality of reconstructed data has a corresponding signal component within the one or more signal components of the captured data.

19. The system of claim 17, wherein the captured data includes seismic data generated from one or more surveys conducted at the resource site.

20. A computer program comprising instructions, that when executed by a computer processor of a computing device, causes the computing device to:
receive captured data including one or more signal components in a first signal space from one or more sensors at a resource site, the captured data including:
a first signal component included in the one or more signal components,
a second signal component included in the one or more signal components, and
a noise component,
determine at least one signal characteristic associated with the first signal component, the second signal component, or the noise component in a second signal space;
transform, based on the at least one signal characteristic, the captured data from the first signal space to the second signal space using a first transform operator, the first transform operator being selected based on a first energy mode of the first signal component that maximizes a first sparsity of the captured data in the second signal space;
extract the first signal component from the transformed captured data in the second signal space, the extracted first signal component being transformed back to the first signal space to generate a first extracted data;
reconstruct the first extracted data to generate a first reconstructed data included in a resolved data;
subtract the first extracted data from the captured data to generate a first minimized data, the first minimized data including at least the second signal component and the noise component;
transform, based on the at least one signal characteristic, the first minimized data from the first signal space to the second signal space using a second transform operator, the second transform operator being selected based on a second energy mode of the second signal component that maximizes a second sparsity of the first minimized data in the second signal space;
extract the second signal component from the transformed first minimized data in the second signal space, the extracted second signal component being transformed back to the first signal space to generate a second extracted data; and
reconstruct the second extracted data to generate a second reconstructed data included in the resolved data, wherein:
the resolved data includes the first reconstructed data and the second reconstructed data, and
the resolved data includes a minimal amount of the noise component relative to an amount of the noise component in the captured data.
